(19) United States
(12) Patent Application Publication
(10) Pub. No.: US 2007/0168487 A1
(43) Pub. Date: Jul. 19, 2007

(54) Computer system, method and software for managing, evaluating, classifying and storing on a server a set of productivity and games software files under server client control for delivery to third parties

(76) Inventor: Remi DuFour, Foster City, CA (US)

Correspondence Address: J G Mullins, Ste. 304, 1618 East Gate Way, Pleasanton, CA, 94566, US

(21) Appl. No.: 11/580,541

(22) Filed: Oct. 13, 2006

Related U.S. Application Data
(60) Provisional application No. 60/741,841, filed on Dec. 2, 2005.

(51) Int. Cl. G06F 15/173

(52) U.S. Cl. 709/223

(57) ABSTRACT

The present invention provides a network multi-channel games and software hosting forum and server management system, comprising a computer system loaded with at least one software module having logic that permits network server clients to individually collect, store, manage, and directly control computer games and software files in their server space as digitally rights managed files with links offered to third parties from a network server client webpage (also know as a “channel”), or in a section of a webpage (“frame space” or area), which may be public or private webpage(s) on the multi-channel games and software hosting server management system. Payment from third parties for their access to the forum and files may be directly to server clients or to the multi-channel forum if there is an agreement with the forum to manage payments and pay server clients a producer's share of revenue.

### FIELD OF THE INVENTION

The field of the present invention relates generally to a network multi-channel games and software hosting forum and server management system, comprising a computer system loaded with at least one software module having logic that permits network server clients to individually collect, store, manage, and directly control computer games and software files in their server space as digitally rights managed files with links offered to third parties from a network server client webpage (also know as a “channel”), or in a section of a webpage (“frame space” or area), which may be public or private webpage(s) on the multi-channel games and software hosting server management system. Payment from third parties for access to the forum and to files may be directly to server clients or to the multi-channel forum under a server client agreement between the forum and the server client for the forum to manage payments and to pay server clients a producer's share of revenue.

### BACKGROUND OF THE INVENTION

Traditionally, games and software media consumers accessed public or private printed, audio or visual media to decide which games or software to purchase, to view, to listen, to try for an evaluation period timed out or limited function software or games prior to making a purchase decision, or to rent the software or game from a games or software rental store to permit home access or productivity. In the past, those standard brick and mortar establishments provided the majority of games or software media to consumers.

Recently, games and software files have become more available over the internet and a rental copy of the media can be mailed to the end user along with postpaid return packaging, so the end user does not need to go to a local games or software rental store that may or may not have the desired media selection. Websites that provide such media for rental are typically large, run by a single provider, and provide only the more popular selections to end users. With timed out version of games and software, end users can also download and try such popular selection games or software and then pay for the software or game. Online access to games and software is more limited with respect to selections available and the quality of software and games files, and may be encrypted, or may be digitally or visually watermarked to prevent copying of the software or game files.

More powerful computers and ready internet access (also know as the World Wide Web) have increased the popularity of games and software transmission over the internet and receipt or use by computers attached to the internet. Servers attached to the internet can act as a large repository of games and software files, which can be down-loaded for access and use. For example, web pages that are available at servers hosting web sites on the internet often include games or software files that can be down-loaded by visitors to the web site or accessed by those visitors via online media access.

There are several complications for games and software file providers and end users, including cost of storage for digital media files on the server, cost of bandwidth for transmission of files to end users from the server and limitations on bandwidth and file format from the computer type and internet connection type of end users, as well as the cost per bandwidth and length of time for transmission to end users or downloading. Just setting up a website, providing the hardware and software, maintaining the site, advertising the site well enough for end users to locate it, and being able to bear the expense of all this can make it nearly impossible for anyone except for the larger and more established games and software file providers.

Accordingly, there is a need for a network multi-channel games and software hosting forum and server management system including software logic that will permit network server clients to individually collect, store, manage, and directly control digital rights managed computer games and software media files in their channel area on the server management system. There is a need for such a system that will allow such network server clients to offer, present and provide connections to such games and software files from their channel forum to third parties along with related information without having to pay for or to manage a website infrastructure. There is a need for such as system that will permit network server clients to provide third parties access to their channel forum of games and software without the need to have the know-how and without need to extend the funds to establish, advertise, manage, and run a large games or software forum website.

Definitions

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Bandwidth Reseller” as referred to in this document refers to a person who leases a transmission bandwidth from a provider and may lease all or a portion of that bandwidth to third parties for data transfer during the lease period.

“Data Transfer Limitations” as referred to in this document may refer to transmission time limitations, bandwidth limitations, total information transferred limitations, and may also be limited to occur within certain time periods.

“Fixed Period Bandwidth Lease” as referred to in this document means that a person leases a certain bandwidth for a certain set period of time (usually monthly), and has a set starting or ending date during which the bandwidth time may be used for data transfer by the person who leases the bandwidth from a provider.

“Floating Time Share Bandwidth” as referred to in this document means that a person can lease a certain bandwidth for a certain amount of time (such as 48 hours), but have a floating starting or ending date during which the bandwidth time (48 hours) may be used for data transfer.

“MBit(s) per hour” as referred to in this document defines the transmission speed of digital data over a transmission system. For example, 1 MBit per hour (bandwidth) for 750 hours would equal a total of 750 MBits transmitted. The greater the transmission speed (bandwidth) permitted or leased, the quicker data can be transferred from one location point along the transmission system to another system location point. MBit/s per hour can also be defined by other unit of times, such as per minute or second without altering the definition.

“Bit(s) Transmission” refers to a total amount of digital information transmitted over an information transmission system. Either the rate limitation (transmission speed, or bandwidth) or the hours of transmission (or both) affect the total amount of digital information that is transferred. A person may be limited to a certain transfer rate (for example 1 MBit per hour) bandwidth in a 750 hour month would permit a maximum transfer of 750 MBits of total information that can be transferred during that month, but might actually be less, if less than the maximum bandwidth is used.

“Games and Software File” as referred to in this document is to be used in its broadest sense to include games or software files with either recreational or productivity intention, wherein the use and licensing of such files is managed in a digital rights management format, and such files may be static (non-interactive, such productivity software files) or dynamic (interactive, such as games, quizzes, puzzles, educational materials, and the like). The form of software may also include photos, presentation slides, flash, animations, movies, and other types of visual files. Online access to games or software would include live online access or access to temporarily downloaded software or games, although they may also be downloaded more permanently in a digital rights managed manner according to a license between the end user and the provider. Except in the claims, when any type of software or game file is referred to (such as a “game”), such is to be regarded as merely an example, and other types of games and software files are also envisioned.

“Network Multi-Channel Forum” as referred to in this document is an internet or intranet accessible forum for digital rights managed software or games hosting wherein an actual or virtual website is parsed into two or more individually managed online channel portions with their individually associated links, rather than a website offering games or software files that are assigned to the general forum for use, rent or sale from that form as a single vendor who is responsible for the look and feel of the whole forum.

“Network Server Client” as referred to in this document is not third party end users of the internet or intranet accessible forum, but is a channel manager who is a subscriber to the digital rights managed multi-channel game and software hosting forum in order to provide third parties end users access to at least one channel forum on the network multi-channel games and software hosting forum.

“On-Line Channel” as referred to in this document means one or more sections of one or more pages, or one or more pages, of a website having games or software files available publicly, or by private invitation, to third parties along with optional online store items for purchasing, wherein the format, selection, availability, and cost of games or software files and optional store items for third party access or purchase are under the control of a channel manager who may permit digital rights managed accessing of games or software files by third parties for playing of game or using of software online, or optionally to permit downloadable digital rights managed games or software files, and the like.

“Periodic Total Data Transfer Limitation” as referred to in this document means that a person is permitted to transfer up to a total data transfer amount (for example, 750 MBits) during a certain period of time, but may (or may not) be restricted to a bandwidth limitation for such transfers of data.

“Producer's Share” as referred to in this document means that a channel owner will have the option to obtain revenue from their individual channel area from the multi-channel games and software forum provider only as a percentage of revenues collected by the forum provider from advertising, sales of items and games or software files access fees from third parties according to a contract formula agreed to between the parties, wherein the parties agree that the multi-channel games and software forum provider will collect any revenues related to advertising, sales of items and games or software file access fees, manage accounting and present to the channel owner revenue gain or loss statements. A report of the balance due or owed will be available to the channel owner from the forum provider. Also, the channel owner may not be in a financial position to collect revenue through various collection agencies, or want to bother with accounting. Since the collections of funds, producer's share calculations and other accounting can be provided by the forum, the channel owner is not required to perform such functions. Further, to optionally avoid unnecessary transaction fees the balances due or payable to the channel owner with respect to the multi-channel games and software forum provider may need to reach a minimum before withdrawal or payment is due.

“Sharing” as referred to in this document with respect to control of content or revenue includes means either or both, direct and indirect managing of the control of content and revenue. In particular, sharing of revenue may be through indirect or direct means, such as through service fees or actual percentages or revenue obtained.

“Channel Manager” as referred to in this document is a server client (subscriber) who only leases or owns a portion of the main multi-channel games and software files hosting website (partitioned games and software files website), over which portion of the website the channel manager is granted control under an agreement with the main multi-channel website (or virtual website) manager, or by a sub-manager who has more than one channel located on the main or virtual website.

### SUMMARY OF THE INVENTION

An object of the present invention is to provide a local or distributed computer software or games file repository in a digital rights managed format and multi-channel server management system, comprising a user interface, a working memory storage area and at least one device for permanently storing information, wherein a portion of said memory of said system is loaded with at least one portion of a computer software program containing logic that permits network server clients to individually collect, store, manage, and directly control digital rights managed format computer games and software files in their channel area on the server management system and to offer, present and provide connections to such games or software files from their channel to third parties along with related information. In a preferred object, payments from third parties for access to the forum and to files may be directly to server clients or to the multi-channel forum under a server client agreement between the forum and the server client for the forum to manage payments and to pay server clients a producer's share of revenue.

In a preferred object of the invention, the network multi-channel games and software hosting forum and server management system includes one or more programs, processes, software, and interfaces permitting network server clients to manage, control or access one or more individual channel features related to an individual channel or area name, content, access, advertising, statistics or interactive features such as surveys and invitations when the channel is part of the network multi-channel games and software hosting forum.

One object of the present invention is to provide a local or distributed computer games or software file repository of digital rights managed files, network multi-channel games and software forum and server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital rights managed games or software files hosted in their channel area on the server management system and for network server clients to offer, present and provide connections to such games or software files from their channel to third parties along with related information.

In a preferred object of the invention such a network multi-channel games and software hosting forum and server management system further comprises one or more software programs, processes, and interfaces that permit network server clients to manage, control or access one or more individual channel features related to an individual channel name, content, access, advertising or statistics when the channel is part of the network multi-channel games and software hosting forum.

In a more preferred object, the present invention provides such a network multi-channel games and software hosting forum and server management system according further comprising software logic and an interface to permit network server clients to choose the payment terms and methods by which third parties can access the games or software files in an individual channel or forum space, and optionally exercise control over collection of such payments. In a preferred aspect, a network server client will have the exclusive right to any revenues collected from the channel forum that they manage or the right to a producer's share of the revenue, but may contract with the network multi-channel forum provider to directly or indirectly share revenues from shared advertising space, a common store, or the like.

Another object of the invention is to provide a network multi-channel games and software hosting forum and server management system, as described above, further comprising software logic and an interface to permit exclusive control for network server clients to post in their individual games and software channel space of the network multi-channel forum information that is accessible to third parties selected from one or more of: pricing; games or software file information; games or software file previews, user screenshots or samples where the preview are in text, audio or video; viewer or listener reviews, ratings of games or software files popularity, user statistics for accessing of games or software files, categorized listings for games or software files located in a channel, and surveys, or feedback forms with respect to files located in their channel or area.

Preferably, the network multi-channel games and software hosting forum and server management system provides ordered and categorized (meaning ranking by all listed categories) statistics for games or software files access including number of times accessed and number of end users who accessed, generated revenues and appreciation marks that are listed according to when the channel first offered the game or software file, the total times it was access since first offered, yearly access, monthly access, weekly access, daily access, hourly access, or a combination thereof.

A further object of the invention is to provide such a network multi-channel games and software hosting forum and server management system as described above, further comprising software logic and an interface to permit exclusive control for network server clients to pay third parties fees or provide gifts and prizes to third parties in return for accessing, using, trying, or playing a game or software file, creating or making a game or software file for uploading to the channel, or providing a review for a game or software file, or taking a survey (that may include questions related to a game or software file).

One preferred object is to provide such a network multi-channel games or software hosting forum and server management system, further comprising software logic and an interface to permit exclusive control for network server clients to select and invite third parties to access and enjoy a software or game file located in their channel forum, or in a different channel forum, wherein the listing and access to a game or software file may be visible or hidden from third parties other than such invitees.

Another preferred object of the invention is to provide such a network multi-channel games and software hosting forum and server management system as described above, further comprising software logic and an interface to permit exclusive control for network server clients to permit third parties to upload or otherwise provide a game or software file to the channel for other third parties to access, wherein the system provides network server clients with software logic and an interface to track revenue from such third party games and software files and compensate the third party for uploading or otherwise providing the game or software file to the channel.

A further preferred object of the invention is to provide a system wherein the network server client has software logic to optionally permit and manage the ability of third parties to submit games or software files to a hosting channel and for the hosting channel to make such games or software files available for accessing by other third parties without the person submitting the game or software file to the channel being required to first pay before placing a game or software file in the channel forum.

One object of the invention is to provide such a network multi-channel games and software hosting forum and server management system as described above, further comprising software logic and an interface to permit contests under the exclusive control of network server clients, or under the control of a forum manager, to pay third parties fees or provide gifts and prizes to third parties in return for the most popular accessed or used game or software file during a set period of time on the hosting channel or on the entire multi-channel games and software hosting forum.

Another object of the invention is to provide such a network multi-channel games and software hosting forum and server management system, wherein the network server client has exclusive control over placement of any advertising media, or links to advertising, located in their channel area or located in media files available in their channel area, and the network server clients have the exclusive right to any revenue from such advertising or links, unless a contract with the network multi-channel games and software hosting forum provides for directly or indirectly shared revenue from certain channel activities. In a further preferred object, the invention provides such a network multi-channel forum and server management system, wherein the network server client has exclusive control over placement of any items for sale in an online store located in their channel or area and to any revenue generated by such sales or from links to items for sale, except as otherwise provided by an agreement between the channel network server client and the network multi-channel website manager.

### DETAILED DESCRIPTION OF THE INVENTION

In one embodiment, the present invention provides a local or distributed computer software or games file repository in a digital rights managed format and multi-channel server management system, comprising a user interface, a working memory storage area and at least one device for permanently storing information, wherein a portion of said memory of said system is loaded with at least one portion of a computer software program containing logic that permits network server clients to individually collect, store, manage, and directly control digital rights managed format computer games and software files in their channel area on the server management system and to offer, present and provide connections to such games or software files from their channel to third parties along with related information. In one aspect, the invention provides that payments from third parties for access to the forum and to files may be directly to server clients or to the multi-channel forum under a server client agreement between the forum and the server client for the forum to manage payments and to pay server clients a producer's share of revenue. With respect to games, players may also purchase “tokens” or “chips” in order to access or play games in one or more channel areas on the multi-channel software and games forum and redeem purchased or won tokens for cash or prizes available on the general forum or in a channel area.

In a preferred embodiment of the invention, the network multi-channel games and software hosting forum and server management system includes one or more programs, processes, software, and interfaces permitting network server clients to manage, control or access one or more individual channel features related to an individual channel or area name, content, access, advertising, statistics or interactive features such as surveys and invitations when the channel is part of the network multi-channel games and software hosting forum. A more preferred embodiment of this embodiment of the invention further provides one or more programs, processes, software, and interfaces permitting payments from third parties for access to the forum and to files, or to purchase tokens or chips that may be purchased directly from server clients or from the multi-channel forum under a server client agreement between the forum and one or more server clients for the forum to manage payments and to pay server clients a producer's share of revenue. With respect to games, in addition to being able to purchase “tokens” or “chips” in order to access or play games in one or more channel areas on the multi-channel software and games forum, the forum programs, processes, software and interfaces provide methods for third parties to redeem purchased or won tokens for cash or prizes that are available on the general forum or in a channel area.

One embodiment of the present invention provides a local or distributed computer games or software file repository of digital rights managed files, network multi-channel games and software forum and server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital rights managed games or software files hosted in their channel area on the server management system and for network server clients to offer, present and provide connections to such games or software files from their channel to third parties along with related information.

In a preferred embodiment the invention provides such a network multi-channel games and software hosting forum and server management system that further comprises one or more software programs, processes, and interfaces that permit network server clients to manage, control or access one or more individual channel features related to an individual channel name, content, access, advertising or statistics when the channel is part of the network multi-channel games and software hosting forum.

In a more preferred embodiment, the present invention provides such a network multi-channel games and software hosting forum and server management system according further comprising software logic and an interface to permit network server clients to choose the payment terms and methods by which third parties can access the games or software files in an individual channel or forum space, and optionally exercise control over collection of such payments. In a preferred aspect, a network server client will have the exclusive right to any revenues collected from the channel forum that they manage or the right to a producer's share of the revenue, but may contract with the network multi-channel forum provider to directly or indirectly share revenues from shared advertising space, a common store, or the like.

Another embodiment of the invention provides a network multi-channel games and software hosting forum and server management system, as described above, further comprising software logic and an interface to permit exclusive control for network server clients to post in their individual games and software channel space of the network multi-channel forum information that is accessible to third parties selected from one or more of: pricing; games or software file information; games or software file previews, user screenshots or samples where the preview are in text, audio or video; viewer or listener reviews, ratings of games or software files popularity, user statistics for accessing of games or software files, categorized listings for games or software files located in a channel, and surveys, or feedback forms with respect to files located in their channel or area.

Preferably, the network multi-channel games and software hosting forum and server management system provides ordered and categorized (meaning ranking by all listed categories) statistics for games or software files access including number of times accessed and number of end users who accessed, generated revenues and appreciation marks that are listed according to when the channel first offered the game or software file, the total times it was access since first offered, yearly access, monthly access, weekly access, daily access, hourly access, or a combination thereof.

A further embodiment of the invention provides such a network multi-channel games and software hosting forum and server management system as described above, further comprising software logic and an interface to permit exclusive control for network server clients to pay third parties fees or provide gifts and prizes to third parties in return for accessing, using, trying, or playing a game or software file, creating or making a game or software file for uploading to the channel, or providing a review for a game or software file, or taking a survey (that may include questions related to a game or software file).

One preferred embodiment provides such a network multi-channel games or software hosting forum and server management system, further comprising software logic and an interface to permit exclusive control for network server clients to select and invite third parties to access and enjoy a software or game file located in their channel forum, or in a different channel forum, wherein the listing and access to a game or software file may be visible or hidden from third parties other than such invitees.

Another preferred embodiment of the invention provides such a network multi-channel games and software hosting forum and server management system as described above, further comprising software logic and an interface to permit exclusive control for network server clients to permit third parties to upload or otherwise provide a game or software file to the channel for other third parties to access, wherein the system provides network server clients with software logic and an interface to track revenue from such third party games and software files and compensate the third party for uploading or otherwise providing the game or software file to the channel.

A further preferred embodiment of the invention provides a system wherein the network server client has software logic to optionally permit and manage the ability of third parties to submit games or software files to a hosting channel and for the hosting channel to make such games or software files available for accessing by other third parties without the person submitting the game or software file to the channel being required to first pay before placing a game or software file in the channel forum.

One embodiment of the invention provides such a network multi-channel games and software hosting forum and server management system as described above, further comprising software logic and an interface to permit contests under the exclusive control of network server clients, or under the control of a forum manager, to pay third parties fees or provide gifts and prizes to third parties in return for the most popular accessed or used game or software file during a set period of time on the hosting channel or on the entire multi-channel games and software hosting forum.

Another embodiment of the invention provides such a network multi-channel games and software hosting forum and server management system, wherein the network server client has exclusive control over placement of any advertising media, or links to advertising, located in their channel area or located in media files available in their channel area, and the network server clients have the exclusive right to any revenue from such advertising or links, unless a contract with the network multi-channel games and software hosting forum provides for directly or indirectly shared revenue from certain channel activities. In a further preferred object, the invention provides such a network multi-channel forum and server management system, wherein the network server client has exclusive control over placement of any items for sale in an online store located in their channel or area and to any revenue generated by such sales or from links to items for sale, except as otherwise provided by an agreement between the channel network server client and the network multi-channel website manager.

In another preferred embodiment the invention provides a rich and innovative set of tools for software and games writers and producers, and other creative individuals in general and others wishing to express themselves by way of games and software media. The tools (software logic and system) have been designed not only to let them create and control an environment to display their work inside a public forum but also to enhance innovation through the multiple interactive features present on the multi-channel games and software hosting forum according to the invention, such as multiple rankings, surveys, feedback, invitation, advertising and other sale opportunities. When properly utilized, this embodiment of the invention will permit such persons or groups of persons to take advantage of those tools to interact with those who share their passion, to discover new ideas and talent, to create innovative work and new source of wealth for themselves, and to keep the forum an unpredictable and fascinating place.

Because the network multi-channel games and software hosting forum according to the invention offers many options to its users, it is also well suited to respond to a broad variety of needs. This forum is therefore able to appeal to a large base of potential channel managers and their colleagues, which is advantageous for any type of forum that gains strength from the number of participants. The versatile design of the forum will permit the attraction of persons having disparate interests to the forum site where the diversity can keep enriching the palette of offerings available to their parties by the forum channels and the overall forum site.

Overall System for one Embodiment of the Invention.

The present invention provides, in one preferred embodiment, a network multi-channel games and software hosting forum and server management system, comprising a computer system loaded with at least one software module having logic that permits network server clients to individually collect, store, manage, and directly control computer games and software files in their server space as digitally rights managed files with links offered to third parties from a network server client webpage (also know as a “channel”), or in a section of a webpage (“frame space” or area), which may be public or private webpage(s) on the multi-channel games and software hosting server management system.

In one embodiment the invention provides such a system with software implemented methods that permits network server clients to offer, present and provide (along with related information) digital rights managed connections to such games or software files to third parties, or optionally provide links for downloading such files in a digitally managed format. In a preferred aspect, the network multi-channel games and software hosting forum and server management system includes one or more programs, processes, software, and interfaces permitting network server clients to manage, control or access one or more individual channel features related to an individual channel name, content, access, advertising or statistics when the channel is part of the network multi-channel games and software hosting forum.

This description introduces, sometimes with a lengthy explanation, the main features of one embodiment of the system according to the invention and aims at connecting them in a way that shows their combination provides a unique service that has not previously been available to the public.

This embodiment of the invention provides a network multi-channel games and software hosting forum and server management system that permits the collection and access to games and software files from/on the internet or intranet in an innovative way. Such collections are within multiple individually managed channel forums of the multi-channel forum, but collections of overall listings, ratings, or other statistics for the entire forum, or parts of the forum, may be included on forum pages accessible to the public and permit access to files on individually managed channel forums.

The system according to the invention provides tools for any subscriber (network server client, or channel manager) to create and control a display environment on the multi-channel games and software forum website. A useful analogy for the forum and associated system is that of a shopping mall where subscribers (channel or area managers) are retailers who select a retail space in the mall, pay fees to operate their store (rent, utilities) and control the nature of their business, the merchandise they sell, and their prices and other marketing strategies. Likewise, in one embodiment, the forum and server management system according to the invention gives subscribers control over a space in a larger environment managed by the forum itself (like mall owners who assume responsibility for facility maintenance).

In one preferred embodiment, the display environment for a channel forum or area is a web page (by use of the term “web page” it is meant both an individual web page or a section of a web page) created within the multi-channel hosting forum specifically for a given subscriber and is identifiable to the forum, and possibly to third parties, as such. In one aspect, a subscriber can choose a transmission plan associated with a page or page portion to enable broadcasting, accessing, or downloading, like a mall retailer would buy utility services to operate essential equipment for conducting its business. Subscribers may select one from several transmission options offered to them at the time of subscription.

In one embodiment, a subscriber can select from the transmission reseller, a flat Mbit(s) of transmission speed for a number of hours. For example, the forum or an agent of the forum could purchase a wholesale transmission plan and resell all or a portion of the transmission bandwidth of the plan. However, in a preferred embodiment, there is provided a floating time-share bandwidth plan. With such a plan, there is included the concept of a beginning and expiration date for an available bandwidth rate, where buyers would get the right to the transmission speed for a specified block of time, to be used between a start date/time and an end date/time of their choice. As in an option contract, the period of availability for a floating time-share bandwidth plan, can be shorter or longer and the cost may vary accordingly.

For an example of a floating time-share bandwidth plan, a subscriber could buy from a reseller (who has leased a higher or equal transmission speed at perhaps a monthly rate transmission speed) a bandwidth of perhaps 720 kbit/s for 96 hours of transmission between Nov. 10, 2005 4 am PST and Nov. 20, 2005 4 am PST. Obviously, the 96 hour period is shorter than the availability dates, and the buyer has a flexibility benefit.

One benefit of such a floating time-share bandwidth plan according to the invention is to give the buyer the possibility of choosing a usage time from among several available time frames, those time frames that are economically relevant to their needs and marketing efforts. An option to exercise a right can be more valuable with longer time of exercise. Thus, a subscriber who purchases four hours of transmission time to be used between today and tomorrow may get charged less than a subscriber who has the same right for an additional three weeks. A particular charge can depend upon subscription levels and a variety of other marketing factors. Depending upon web traffic conditions, the floating time-share bandwidth marketing procedure according to this invention can make it possible for a forum channel manager, or their agent, to offer the best price to subscribers and to enhance the quality of services provided.

In one embodiment of the invention, the control of a channel forum on the multi-channel games and software hosting forum according to the invention is one or more web pages and storage areas wherein control is enabled by a series of tools that the forum makes available to subscribers. Those tools include software to upload games and software from a place designated by subscriber (storage on a computer or other electronic devices) to the webpage, or individual channel forum or space. Along with software or games, subscribers can upload information related to the game or software such as pictures, screen shots, reviews, recorded segments of the game or software being used, text and the like. See below, regarding information related to the game or software. In a preferred aspect of the invention, subscribers can indicate preferences pertaining to the way a game or software file will be presented to the public or accessed. Such preferences can include pay-per-access, general user fee, free and donation. See, compensation explanations below.

In a preferred embodiment of this invention, the display or access environment of a channel is made operational by software logic owned or operated by the forum. Of course, the site software will include logic that enable the access, use or downloading of the game or software at users' request by temporary file, online access, or by downloading. In addition to that primary function, such software logic in a more preferred embodiment will also track data related to accessing of games or software files, give usage reports to subscribers, and calculate and maintain their transmission account. With that maintenance, subscribers can keep track of usage and can make decisions to purchase additional transmission time with similar characteristics or not.

From the above paragraphs it is clear that the system according to the invention will permit subscribers to control the creation, content, access, and performance of their hosting environment (channel). Such control is automatically given to subscribers for them to be channel managers of their channel located within the multi-channel games and software hosting forum. The object of the control (entire and identifiable section-a channel), as well as the degree of control, provide novel and unexpected advantages for the present invention. See the discussion of the invention forum aspects, below, for additional details.

Conceptually, the forum allows any one with ownership rights to games and software files to come to the forum site and make their game or software files available to third parties in the way they choose, in their own web-page or section of the forum just by subscribing to the forum. The forum also allows them to collect proceeds from the access of their games and software (see the discussion of compensation, below, for additional details), or from sales of articles of licenses connected to their games or software, if any (see the discussion below regarding online sales.)

The forum will own, operate, or both own and operate software programs having logic that will allow registered third party users of a channel forum or area to access, use, or download games or software files located within available channels according to the terms imposed by controlling subscribers.

The software programs of the forum contain logic that collects information on games or software loaded on its servers and on file or area accessing activities. It processes that information to provide statistics and uses those statistics to maintain rankings on games or software (see the section below regarding rankings or rankings by sales). The forum may classify games or software located within channels of the forum according to several different categories, nested and not, by genres and by time of load up.

Such information processing by the forum can facilitate access choices for third party users of channel files located on the multi-channel games and software hosting forum and enhance their experience with the forum, in general. However, in this preferred embodiment, the forum is more than just a games and software repository system that replicates the traditional games evaluations and software samples experience at home or in stores.

The forum provider will own, operate, or both own and operate software with logic that makes it possible for games and software file users (third party site users) and owners (or channel managers) to interact in a number of ways. The forum can provide the tools to develop an interactive community, which can foster increased artistic creation and profitability by giving games and software owners more insights into what the interests of the accessing public are.

Rankings maintained by the multi-channel forum can indicate which games and software are popular, their quality, and also their earning potential. That alone can be a tool for games and software owners-makers and the accessing public to communicate implicitly.

In one aspect of the invention, the multi-channel games and software hosting forum manager can own, operate, or both own and operate software with logic that permits games and software owners (or channel managers/subscribers) the option to propose that the accessing public fill-in a questionnaire designed by the games or software owners (or channel manager), for compensation or for free. Game or software owner (or channel managers as games and software producers) will have therefore a tools at their disposal to collect feedback about their games and software. See the discussion of survey services, below.

In a further aspect of the invention, the forum manager can own, operate, or both own and operate software with logic that permits games or software owners, or channel managers, to invite groups of their choice to access games or software. The selection of groups can be based upon a number of factors, such as accessing history, demographics, or both. See below the details for invitation services. Such a tool combined with a questionnaire (survey) tool can allows games or software owners, or channel managers, to determine precisely what the taste of a specific group is just by using its forum account.

In some instances, a forum manager may own or operate software with logic that allows third party users of a channel on the forum to post a review for any game or software file that they have accessed or used. Lists of reviews can be sorted by many different criteria including file listing type and reviewers. Since part of the public may be attached on a specific person's opinion in order to select which game or software file to access or use, the sorting criteria makes it easy for them to see all reviews written by that person and select games or software to access or use, accordingly. Conversely, a game or software owner, or channel manager, can readily access all the reviews posted for one game or software file and learn from it.

When game or software owners provide a game or software file for third party accessing or use, they may wish to permit third parties to contact them. A message system for the network multi-channel games and software hosting forum will allow any user to contact a game or software owner who wishes to be contacted.

The above possible combinations of feature examples, when aligned with the innovative forum and purpose of a network multi-channel games and software hosting forum, can provide a novel way to develop a new, open community to any one with games or software, from small to big, and to any person with an interest in games or software of a particular genre where such parties can interact and add value to the forum community.

Furthering the idea of a community where interest can be met is a feature offered to subscribers with games and software that become part of the forum according to the invention. Subscribers are able to write a business proposition, explaining their purposes for their business, their competencies and any offerings/requests for services, and post such a proposition in a prominent place in the section they control. The public will be able to view their proposition as well as games and software showcasing examples of their creativity and follow up if they desire by contacting games or software owners by way of the forum messaging system. (See details below regarding internal services.)

In the same vein, games and software creators can directly engage the public for ideas to develop/end the design of a game or software by way of surveys. Both of these examples illustrate the high degree of possible interaction between games or software makers and the accessing/using public that can be achieved with the forum and associated system.

As mentioned above, in one preferred embodiment, the forum and system can own, operate, or both own and operate one or more software programs having logic that permits a forum manager to classify and rank games and software according to certain data and statistics. This, along with the interactive feature described above, make the forum experience rewarding from the standpoint of the person who accesses or uses games and software. It's also the case for those who own games or software and would like to distribute their game or software for sale, as the creation of a well-functioning open community enabling interaction is likely to increase demand for games or software that are hard to access otherwise. In addition to increasing demand, the forum according to the invention provides tools to promote talent and enhance visibility, such as the visible and ubiquitous new games and software section and charts, and a new game or software contest that can reward high-ranking performers with prestige and prominence. Even for games and software that are not on the top of the charts, the forum and its statistics can provide an unbiased, multi-dimensional reference for games and software owners to point to when promoting their work.

In a more preferred embodiment of the invention, as described above, games and software owners will be able to point to the forum and its statistics to illustrate the revenues generated by their games or software, or the number of accessing or using persons, the quality indicators, or reviews. A good performance may generate recognition and enhance a software or game creator's career.

The forum according to the invention will also present games and software owners with some tools that will enable them to generate revenues from file access or use, from advertising, or from both. In addition to creating an interactive community, where such a community environment can enhance or bring fame to game or software owners, the forum can also provide tools to directly monetize those assets by collecting revenues.

In one of its more preferred aspects, the forum an system according to the invention will provide a unique mechanism to allow games and software owners to automatically attach advertisements (videos) to their game or software and to get compensated for it (see the details below regarding attached advertisements).

Unlike distributors who do not let games or software owners directly control part of their website that might interface with users, the forum according to the invention will provide such an option. Also, the forum according to the invention will permit a subscriber to reserve a space for that subscriber to control, instead of the games or software distributor controlling the whole space.

According to a preferred embodiment of the invention, a channel forum on a network multi-channel games and software hosting forum may be a web page within the main forum page on the forum website, or a portion of a page, where the channel is controlled by the designated subscriber(s). Preferably, that subscriber can lists games or software files with file information and other file-related items, from which listing each game or software can be launched and accessed by the public (provided the public registers first with the forum, with the channel, or with both). In a preferred aspect of the invention, controlled means that only the designated subscribers will have the ability to include software or game files in and remove software or game files from the list of their channel forum. Of course, the multi-forum managers can reserve the right to withdraw material from the list but only as recourse against abuses or a user's agreement violation. A subscriber may have the option to name the channel and refer to that name to designate their space.

A subscriber to the forum (channel manager) can also have the option to choose among different types of channels to find the best match for their needs. Offered channel types can be: General (no restriction), Hidden (accessible with password and invitation only and not referenced in any part of the forum), and PPV only (this type of channel can impose the PPV type of compensation for all posted software or game files).

In a more preferred aspect, the present invention provides such a network multi-channel games and software hosting forum and server management system according further comprising software logic and an interface to permit network server clients to choose the payment terms and methods by which third parties can access the games and software files in an individual channel forum space, and optionally control over collection of such payments. In a further preferred aspect, a network server client will have the exclusive right to any revenues collected from the channel forum that they manage, but may contract with the network multi-channel forum provider to directly or indirectly share revenues from shared advertising space, a common store, or other similar joint undertakings. In one aspect, the invention provides such a network multi-channel forum and server management system, wherein the network server client has exclusive control over placement of any items for sale in an online store located in their channel area and to any revenue generated by such sales or from links to items for sale, except as otherwise provided by an agreement between the channel network server client and the network multi-channel games and software website manager.

Another embodiment of the invention provides a network multi-channel forum and server management system, as described above, further comprising software logic and an interface to permit exclusive control for network server clients (subject to agreements, laws, and regulations) to post in their individual channel space of the network multi-channel forum information that is accessible to third parties selected from one or more of: pricing; software or games file information; software or games file previews or samples where the preview are in text, audio or video; viewer or listener reviews, ratings of games or software file popularity, user statistics for access of games or software files , categorized listings for games or software files located in a channel forum, and surveys, or feedback forms.

In a preferred aspect, the network multi-channel forum and server management system can provide statistics for games and software files located in multiple channels of the forum in an ordered and categorized (meaning ranking by all listed categories) set of statistics with respect to software or games files access including number of users and viewers, generated revenues and appreciation marks that are listed according to when the channel first offered the game or software file, the total times accessed since first offered, yearly access, monthly access, weekly access, daily access, hourly access, or a combination thereof.

A further embodiment of the invention provides such a network multi-channel forum and server management system as described above, further comprising software logic and an interface to permit exclusive control for network server clients to pay third parties fees or provide gifts and prizes to third parties in return for access to or evaluating a game or software file, creating or making a game or software file for uploading to the channel, or providing a review for a game or software file, or taking one or more surveys that may include questions related to a game or software file in a particular channel forum.

One preferred embodiment of the invention provides such a network multi-channel forum and server management system, further comprising software logic and an interface to permit exclusive control for network server clients to select and invite third parties to access and enjoy a file located in their channel forum, or in a different channel forum, wherein the listing and access to a game or software file may be visible or hidden from third parties other than such invitees.

One embodiment of the invention provides software implemented methods for providing software or game files uploaded to the multi-channel games and software hosting forum with date stamping, software keys, user keys or other security digital rights managed methodology in order to control user access and use of such files as directed by the owner of the game or software file that uploads the file to the multi-channel forum.

The present invention may be embodied in specific forms other than those particularly described above or illustrated by the above examples. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and examples, as indicating the scope of the present invention.

I claim:

1. A local or distributed computer digital media file repository, network multi-channel games and software forum and server management system, comprising a user interface, a working memory storage area and at least one device for permanently storing information, wherein a portion of said memory of said system is loaded with at least one portion of a computer software program containing logic that permits network server clients to individually collect, store, manage, and directly control computer games or software files in their channel area on the server management system and for network server clients to offer, present and provide connections to such games or software files from their channel to third parties along with related information, wherein payments from third parties for access to the forum and to files may be directly to server clients or to the multi-channel forum under a server client agreement between the forum and the server client for the forum to manage payments and to pay server clients a producer's share of revenue, and with respect to games, players may optionally purchase “tokens” or “chips” in order to access or play games in one or more channel areas on the multi-channel software and games forum and may optionally redeem purchased or won tokens for cash or prizes available on the general forum or in a channel area.

2. A network multi-channel games and software forum and server management system according to claim 1, further comprising one or more software programs, processes, and interfaces that permit network server clients to manage, control or access one or more individual channel area features related to an individual channel name, content, access, advertising, statistics, surveys, and invitations when an individual channel is part of the network multi-channel games and software files forum.

3. A network multi-channel games and software forum and server management system according to claim 2, further comprising software logic and an interface to permit network server clients to choose the payment terms and methods by which third parties can access the games or software files in an individual channel area or forum location, and may optionally further comprise software with logic for the forum itself to manage one or more of billing, collecting, allocating, or dispersing of funds from third parties who directly or indirectly access an individual channel or forum space to watch, listen, use, or play games or software files or to post at least one advertisement within the individual channel or forum space.

4. A network multi-channel games and software forum and server management system according to claim 2, further comprising software logic and an interface to permit the forum itself or an associated forum provider to provide, manage, or provide and manage, network server client accounts with periodic total data transfer limitations, periodic fixed bandwidth limitations, or floating time share bandwidth limitations.

5. A network multi-channel games and software forum and server management system according to claim 2, further comprising software logic and an interface to permit exclusive control, or control shared with the forum, for network server clients to post in or on their individual channel space, where the channel space may include one or more web pages, links or information that are accessible to third parties items selected from one or more of: pricing; games or software file information; games or software file previews, screenshots, or samples where the preview are in text, audio, graphics or video; viewer or listener reviews, ratings of games or software files popularity, using or accessing statistics for games or software files, categorized listings for games or software files in the channel, content listings, and survey feedback forms.

6. A network multi-channel games and software forum and server management system according to claim 2, further comprising software logic and an interface to permit a network server client to share revenue or control over one or more of advertising spaces, links, or channel area files with another network server client or with a network multi-channel games and software forum provider.

7. A network multi-channel games and software forum according to claim 2, wherein the software and logic permits posting in an individual channel area, on forum pages, or both, statistics for games or software files that includes one or more statistics related to the number of times a file is accessed or used, since first offered, yearly access or use, monthly access or use, weekly access or use, daily access or use, or hourly access or use.

8. A network multi-channel games and software forum and server management system according to claim 7, wherein the software and logic provides one or more listing of statistics for games or software files accessed or used in individual channels, in groups of channels, or in all the channels of the forum, and games or software file access or use statistics are listed according to when the channel first offered the game or software file, the total times accessed or used since first offered, yearly access or use, monthly access or use, weekly access or use, daily access or use, hourly access or use, or a combination thereof.

9. A network multi-channel games and software forum according to claim 8, wherein the forum provides one or more forum statistics pages having ordered and categorized statistics with rankings within all listed categories, overall rankings, or both.

10. A network multi-channel games and software forum according to claim 9, wherein the statistics for games or software files include one or more sets of statistics related to one or more of the number of times accessed or used and number of individuals who accessed or viewed the files, generated revenues, and user or expert appreciation ratings for games or software files in a single channel area, in a group of channel areas, or in all the channels.

11. A network multi-channel games and software forum according to claim 10, wherein the statistics for games or software files includes one or more statistics related to the number of times a file is accessed or used, since first offered, yearly access or use, monthly access or use, weekly access or use, daily access or use, or hourly access or use.

12. A network multi-channel games and software forum according to claim 2, wherein forum statistics are provided that rate for third parties all of the channels on the forum, or a group of channels, according to their popularity, which popularity may be measured by one or more factors selected from number of games or software files, revenue, number of times files are accessed or used, number of individuals who access or use files, and appreciations ratings by individuals who access or use files or by experts.

13. A network multi-channel games or software forum and server management system according to claim 2, further comprising software logic and an interface to permit exclusive control for network server clients to pay third parties fees or provide gifts and prizes to third parties in return for accessing or using a game or software file, creating or making a game or software file for uploading to the channel, or providing a review for a game or software file.

14. A network multi-channel game or software forum and server management system according to claim 2, further comprising software logic and an interface to permit exclusive control, or shared control, for network server clients to select, to invite, or both select and invite, third parties to access and enjoy or use a game or software file located in their channel area or forum, or in a different channel area or forum, wherein the listing and access to a game or software file of a channel or forum area may be visible or hidden from third parties other than such invitees.

15. A network multi-channel games and software forum and server management system according to claim 2, further comprising software logic and an interface to permit exclusive control for network server clients to permit third parties to upload or otherwise provide a game or software file to the channel or forum area for other third parties to access or use, wherein the system provides network server clients with software logic and an interface to track revenue from such third party games or software files and compensate the third party for uploading or otherwise providing the game or software file to the channel or forum area.

16. A network multi-channel games and software forum and server management system according to claim 2, further comprising software logic and an interface to permit contests under the exclusive control of network server clients, or a forum manager, to pay third parties fees or provide gifts and prizes to third parties in return for the most popular accessing, downloading, using, or playing of a game or software file, or a group of games or software files, during a set period of time on the channel, or on the overall multi-channel forum.

17. A network multi-channel games and software forum and server management system according to claim 14, wherein popular accessing or using, may be one or more of highest revenues, highest quality ratings, highest number of times a file is accessed or used, the highest number of individuals to access or use a file or group of files, or the highest number of token purchased or redeemed.

18. A network multi-channel games and software forum and server management system according to claim 2, wherein the network server client has exclusive or shared control over placement of any advertising media, or links to advertising, located in their channel area or located within or associated with files available in their channel area, and the network server clients have the exclusive or shared right to any revenue from such advertising or links.

19. A network multi-channel games and software forum and server management system according to claim 2, wherein the network server client has exclusive or shared control over placement of any items for sale in an online store located in, or accessible from, their channel or forum area and to any revenue generated by such sales or from links to items for sale.

20. A network multi-channel games and software forum and server management system according to claim 15, wherein the network server client has software logic to permit and manage the ability for a third party or a network server client to provide games or software files to the channel or forum area, or to the general forum, for the channel or general forum to make them available for access or use by other third parties without first paying for placement of the games or software files in the channel area or general forum.
